(19) United States
(12) Patent Application Publication
(10) Pub. No.: US 2025/0173765 A1
(43) Pub. Date: May 29, 2025

(54) METHOD OF DISPLAYING PROFILE VIEW IN INSTANT MESSAGING SERVICE

(71) Applicant: KAKAO CORP., Jeju-Si (KR)

(72) Inventors: Hyo Jin Ham, Seongnam-Si (KR); Ha Young Kim, Seongnam-Si (KR); So Ra Lee, Seongnam-Si (KR); Jeong Min Yun, Seongnam-Si (KR); Seong Hoon Kim, Seongnam-Si (KR); Do Yeon Kim, Seongnam-Si (KR); Ji Hwi Park, Seongnam-Si (KR); Se Hyeong Kim, Seongnam-Si (KR); Seung Hyup Han, Seongnam-Si (KR); Hye Mi Lee, Seongnam-Si (KR)

(21) Appl. No.: 19/040,556

(22) Filed: Jan. 29, 2025

Related U.S. Application Data
(63) Continuation of application No. 17/073,494, filed on Oct. 19, 2020.

(51) Int. Cl. G06Q 30/0251; G06Q 30/0241; G06Q 50/00; H04L 51/04; H04L 51/52

(52) U.S. Cl. CPC G06Q 30/0271; G06Q 30/0277; G06Q 50/01; H04L 51/04; H04L 51/52

(57) ABSTRACT

A method of displaying a profile view in an instant messaging service includes providing at least one set item applicable to the profile view for the personal account, applying a set item selected by the user from the set item to the profile view, providing an edit view for editing at least one profile item included in the set item applied to the profile view, and displaying a profile view edited through the edit view.

### CROSS-REFERENCE TO RELATED APPLICATION(S)

This application is a continuation of U.S. application Ser. No. 17/073,494, filed on Oct. 19, 2020, which claims the priority benefit of Korean Patent Application No. 10-2019-0129609 filed on Oct. 18, 2019, in the Korean Intellectual Property Office, the disclosure of which is incorporated herein by reference for all purposes.

### BACKGROUND

### 1. Field

Example embodiments relate to a method and an apparatus for displaying profile view in an instant messaging service.

### 2. Description of Related Art

With the advent of various smart devices including a smartphone, various types of social network services (SNS) are being used. In particular, an instant messaging application in which a plurality of users opens a chat room and exchange messages in the chat room in real time is widely used. A chat service based on the instant messaging application is also being developed to have various functions to satisfy requirements of users. As a service area that can be provided through the instant messaging application is expanded, a possibility of a versatile use of a profile view that expresses each user is also increasing beyond simply providing a profile image.

### SUMMARY

According to an aspect, there is provided a method of displaying a profile view for a personal account of a user in an instant messaging service, the method including: providing at least one set item applicable to the profile view for the personal account; applying a set item selected by the user from the at least one set item to the profile view; providing an edit view for editing at least one profile item included in the set item applied to the profile view; and displaying a profile view edited through the edit view.

The providing of the at least one set item may include determining whether the personal account satisfies a predetermined condition related to an official account or an advertiser and providing the at least one set item based on whether the condition is satisfied. The set item may include at least one profile item associated with the official account or the advertiser.

The predetermined condition may include a first condition of establishing a friend relationship with the official account. The predetermined condition includes at least one of: a second condition of requesting an access to advertisement content provided in association with the official account or the advertiser; and a third condition of participating in an event provided in association with the official account or the advertiser.

The predetermined condition may further request a first-come-first-served condition based on a limited number of people set in association with a provision of the set item to correspond to at least one of the second condition and the third condition.

The at least one profile item may include at least one type among a music item, a logo item, a sticker item, a text item, a link item, a background effect item, a D-day item, a background image item, a background video item, and a feedback item.

The applying may include removing a first profile item applied to the profile view and applying a second profile item included in the selected set item to the profile view.

The removing of the first profile may include identifying a type of the first profile item and determining whether to remove the first profile item based on the type of the first profile item.

The applying may include determining whether a type of a first profile item applied to the profile view and a type of a second profile item included in the selected set item are duplicated and applying the second profile item to the profile view based on a result of the determining.

The applying of the second profile item to the profile view may include replacing the first profile item with the second profile item or applying the second profile item to the profile view with keeping the first profile item in accordance with a determination that the type of the first profile item and the type of the second profile item are duplicated.

The method may further include receiving, from a server providing the instant messaging service, a recommended list that recommends an advertisement profile view and a profile view of a personal account of at least one another user in a friend relationship with the personal account, and displaying the recommended list through a predetermined area in a friend list view showing a friend list of the personal account.

At least one of a position at which the advertisement profile view is displayed in the recommended list and a period of time for which the advertisement profile view is displayed may be set in advance.

The providing of the set item may include providing the advertisement profile view to the user in response to a user input of selecting the advertisement profile view in the recommended list, and removing the advertisement profile view in the recommended list in response to the advertisement profile view being provided.

The method may further include determining whether the personal account satisfies a predetermined condition when an input of applying a set item included in the advertisement profile view is received from the user, and providing a user interface for inducing the predetermined condition to be satisfied in accordance with a determination that the personal account does not satisfy the predetermined condition.

The method may further include at least one of: displaying a banner advertisement related to the set item in a form associated with a button for accessing the edit view at a time when the edit view is accessible; and displaying the banner advertisement related to the set item in the edit view.

The method may further include accessing an edit view for editing a profile view to which the set item is applied in response to a selecting input of the user for the banner advertisement.

The providing of the set item may include displaying, through an interface of the edit view, a set item list including at least one set item provided in the instant messaging service and a set item associated with an official account or an advertiser.

The displaying of the set item list may include displaying a set item of the official account or the advertiser as a locked state in the set item list in accordance with a determination that the personal account does not satisfy a predetermined condition related to the official account or the advertiser.

The method may further include providing a user interface for inducing the predetermined condition to be satisfied when the set item displayed as the locked state is selected from the set item list, unlocking the set item when the predetermined condition is satisfied through the user interface, and editing the profile view by applying the unlocked set item.

The method may further include displaying either an advertisement profile view including the set item or an edit view showing a set item list including the set item in response to a selection of a link item that is included in a profile view of an official account or a profile view of a personal account of another user and that is linked to the set item of the official account.

The method may further include displaying either an advertisement profile view including the set item or an edit view showing a set item list including the set item in response to a selection of a link item that is included in a profile view of a personal account of another user and that is linked to the set item of an advertiser.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a configuration of a system for providing a profile view displaying method according to an example embodiment;

FIG. 2 is a flowchart illustrating a method of displaying a profile view according to an example embodiment;

FIG. 3 is a diagram illustrating a method of providing a set item according to an example embodiment;

FIG. 4 is a diagram illustrating a method of displaying a banner advertisement related to a set item according to an example embodiment; and

FIGS. 5 and 6 are diagrams illustrating a method of inducing a personal account of a user to establish a friend relationship with an official account to provide a set item according to example embodiments.

### DETAILED DESCRIPTION

Specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, some example embodiments will be described in detail with reference to the accompanying drawings. Like numbers refer to like elements throughout the description of the figures.

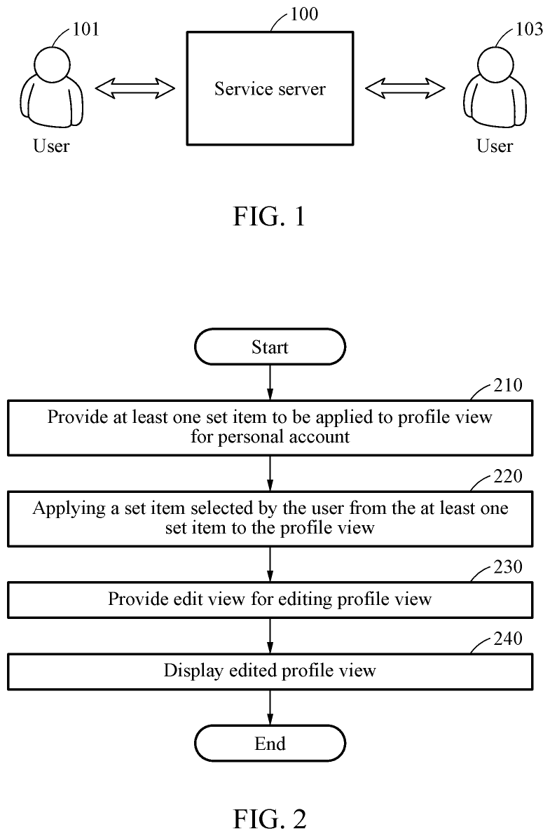

FIG. 1 is a diagram illustrating a configuration of a system for providing a profile view displaying method according to an example embodiment. FIG. 1 illustrates a service server 100, a first user 101, and a second user 103 according to the example embodiment.

The service server 100 may be, for example, a server that provides an instant messaging service. The service server 100 may generate a user account for each of the first user 101 and the second user 103 and provide an instant messaging service to the first user 101 and the second user 103 through a messenger application installed in a terminal of the first user 101 and a terminal of the second user 103. A user account may include at least one type of, for example, an official account and a personal account. The personal account may be an account for a general individual user. The official account may be an account for using additional functions associated with the instant messaging service and may include, for example, a corporate account for corporate users, and the like. The functions provided through the official account may include a function of sending an advertisement message to users who have a friend relationship with the official account, or a function of sending an informative message to specific users irrespective of a friend relationship. Hereinafter, for ease and convenience, a description will be given based on the individual user and the corporate user. However, it is merely an example, and the corporate user may be understood as a concept that generically refers to a user who belongs to or represents a particular company as well as a user who uses the official account.

The service server 100 may correspond to a service platform that provides the instant messaging service to clients such as the corporate user, the individual user, and the like. The messenger application may include a computer, a database, a module, or a program operated to perform, for example, a function of writing and transmitting text, a function of transmitting multimedia content (e.g., voice, image, video, etc.), a message alert function, a schedule function, and the like.

The first user 101 and the second user 103 may access the service server 100 through a terminal in which a messenger application is installed. The first user 101 and the second user 103 may be the individual user having the personal account or the corporate user having the official account.

The terminal of the first user 101 and the terminal of the second user 103 may be one of electronic devices such as a computer, an ultra-mobile personal computer (UMPC), a workstation, a net-book, personal digital assistants (PDA), a portable computer, a web tablet, a wireless phone, a mobile phone, a smartphone, an e-book, a portable multimedia player (PMP), a portable game player, a navigation device, a black box, or a digital camera, and may include all user devices in which a messenger application associated with the service server 100 is to be installed and executed. A user device may perform overall instant messaging service operations such as, for example, configuring a service screen, inputting data, transmitting and receiving data, and storing data under a control of the messenger application.

The messenger application may be implemented to be used in a personal computer (PC) environment and a mobile environment, and implemented in a form of a program operated independently or in an in-app form of a specific application so as to operate in the specific application.

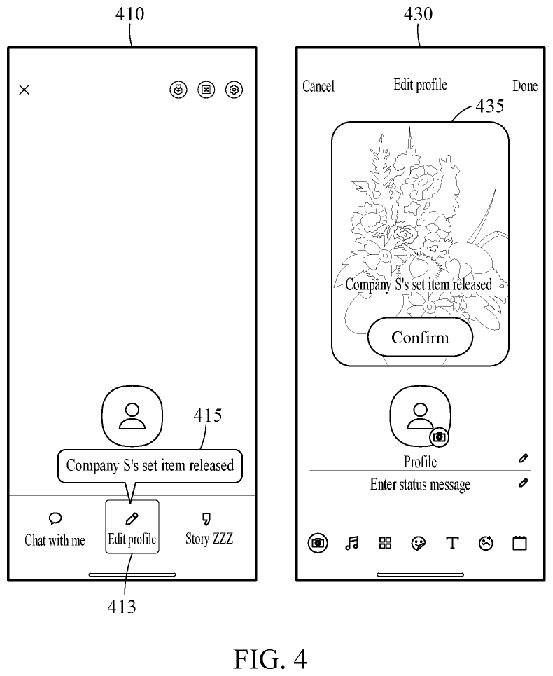

As described below, the instant messaging service may provide a technique for improving an availability of a profile view provided on the messenger application. The “profile view” may be a service screen representing a profile of a user and may be displayed on a display of a user terminal as shown in a screen 360 of FIG. 3, for example. The profile view may include, for example, a profile image and profile information provided in association with a user account of the corresponding user. In addition to the profile image and the profile information, the profile view may further include profile items such as a profile background, a sticker, and the like for expressing the corresponding user in various ways. The profile view may include, for example, different information based on settings of the corresponding user.

According to the example embodiment, a set item including at least one profile item may be provided. By using the set item, the user may uniformly apply a profile item(s) included in the corresponding set item to a profile view of the user. As described below, after the set item is applied, the user may freely edit the profile item(s) applied to the profile view through an edit view.

The “set item” may include a plurality of profile items applicable to the profile view for the personal account and/or combinations of the profile items. The set item may be, for example, a set item provided basically irrespective of the official account in the instant messaging service, or a set item of the official account provided to correspond to the official account. The set item may include various types of profile items such as a music item, a logo item, a sticker item, a text item, a link item, a background effect item, a D-day item, a background image item, a background video item, a feedback item, and the like displayed through the profile view. The music item may include, for example, a playlist of a sound source played through the profile view and a display style of the playlist.

In the example embodiment, the set item may be, for example, one set item including one profile item, or a plurality of set items including a plurality of profile items by concept, by theme, and by style.

According to the example embodiment, the set item may be associated with a specific official account or associated with a specific advertiser who does not have an official account. For example, at least one profile item included in the set item may be associated with a specific official account or a specific advertiser. The set item being associated with the specific official account or specific advertiser may be understood as that information provided to users through the set item is associated with the specific official account or specific advertiser. Depending on embodiments, at least one profile items included in the set item may be individually associated with content of the specific official account or specific advertiser, or a combination of profile items included in the set item may be associated with content of the specific official account or specific advertiser.

The terminal may provide an edit view for editing the at least one profile item included in the set item applied to the profile view. The edit view may provide an editing function for applying the aforementioned at least one profile item to the profile view.

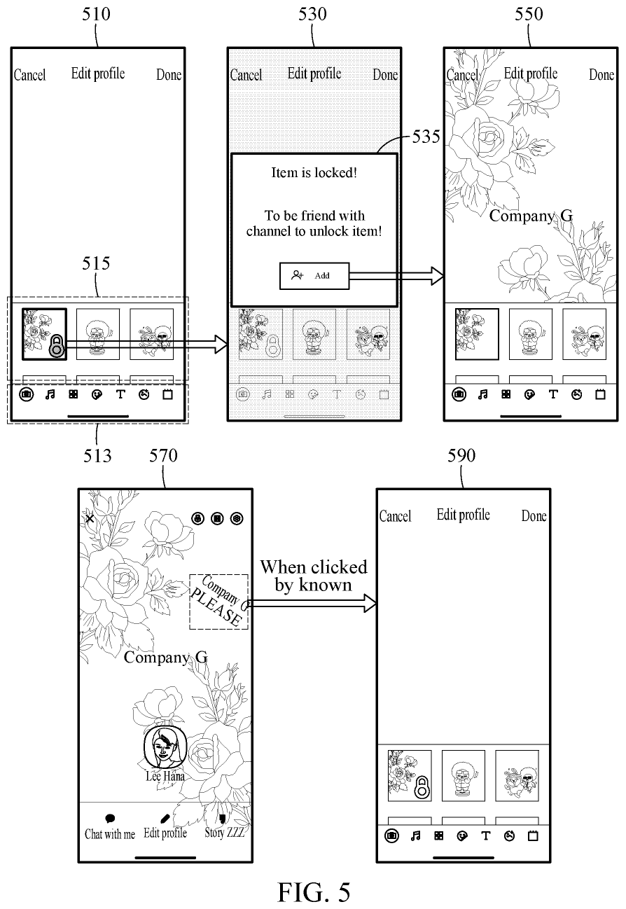

A user A may edit a profile view of the user A through an edit view such as an edit view screen 430 of FIG. 4 in various ways. For example, the user A may select at least one profile item to be applied to the profile view of the user A from profile items included in a set item. Alternatively, the user A may variously edit the profile view of the user A using an editing function provided through an edit view, such as replacing a profile item present in the profile view of the user A with another profile item included in the set item or changing positions of other profile items. The edit view may provide, for example, a preview function for checking an edit result of the profile view in real time during the editing.

The terminal may edit the profile view by applying the profile item edited by the user A and/or the set item selected by the user A to the profile view. The terminal may display the edited profile view.

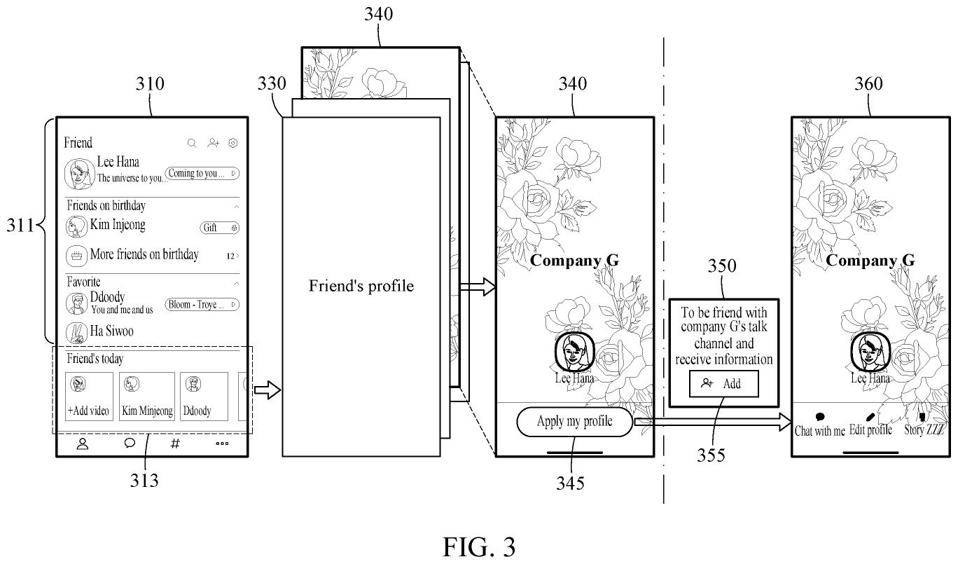

According to the example embodiment, the set item may be provided based on whether a predetermined condition is satisfied. For example, when the personal account of the user A satisfies the predetermined condition, the terminal may provide at least one set item applicable to the profile view of the user A. According to the example embodiment, the set item associated with the specific official account or the specific advertiser may be provided based on whether a predetermined condition associated with the corresponding official account or the corresponding advertiser is satisfied. The predetermined condition will be further described in detail with reference to FIG. 2.

The set item may be displayed on the below-described set item list as a locked state or an unlocked state based on whether the personal account of the corresponding user satisfies the predetermined condition. When the set item is displayed as the locked state, the terminal may not edit the profile view by applying the corresponding set item to the profile view or provide the corresponding set item. The set item displayed as the locked state may be unlocked and displayed in response to the personal account of the corresponding user satisfying the predetermined condition.

According to example embodiments, the set item may be provided to the user on the instant messaging service in various ways.

The service server 100 may display recommended information through a friend list view such as, for example, a friend list view screen 310 of FIG. 3 described below. The “recommended information” may correspond to, for example, a profile view of a recommended friend who satisfies a predetermined recommendation condition of the service server 100 such as a profile (e.g., a profile of a friend who has registered a video as a background of a profile view) of a friend who has edited within a predetermined period of time (e.g., 24 hours or today). When the recommended information includes a plurality of recommended profile views, the terminal may sort the recommended profile views and display recommended profile views based on a sorting result.

As described in detail below, according to the example embodiment, a recommended list including recommended information may be used to provide (or recommend), to the user, the set item including at least one profile item associated with the specific official account. The friend list view may be a view interface for displaying data nodes stored in a list data structure. The friend list view may include list elements corresponding to the data nodes stored in the list data structure.

For example, the friend list view screen 310 of FIG. 3 may display a plurality of friends included in a friend list 311 in units of a row. The friend list 311 may be understood as a list corresponding to user accounts of a plurality of friends. In this instance, the plurality of friends included in the friend list 311 may receive the instant messaging service provided through the service server 100, and may correspond at least one another user having a friend relationship with the personal account of the corresponding user. Information on the plurality of friends included in the friend list 311 may be stored in a corresponding data node in a list data structure. Also, the friend list view like the friend list view screen 310 may display the corresponding information using each list element corresponding to the data node. When the plurality of friends is displayed in the friend list view in units of row, each row of the friend list view may correspond to an individual list element.

The recommended information may be displayed through a predetermined recommendation area in the friend list view. The recommended information may be displayed in the recommendation area in a form of, for example, a thumbnail of a recommended profile view. In this case, a number of recommended profile views displayed in the recommendation area may be set in advance.

The recommendation area may include, for example, a separate recommended list 313 distinguished from the friend list 311 displayed in the friend list view screen 310 of FIG. 3. According to the example embodiment, the recommended list 313 may be implemented using a different type list element from list elements of a type for the friend list 311.

According to the example embodiment, the recommended list 313 may further include an advertisement profile view in addition to a profile view of a personal account of at least one another user having a friend relationship with the personal account. The advertisement profile view may be a profile view that promotes or recommends a product or service of an official account or an advertiser to a user through the set item associated with the official account or the advertiser. For example, a specific set item may be provided (or recommended) to the user by inserting a profile view for advertising the set item in the recommended list 313 including friend's profile views edited within a predetermined period of time.

For ease and convenience, the above description is given based on the personal account of another user having the friend relationship with the personal account of the corresponding user. However, it is merely an example, and the substantially same operation may be performed for a relationship of a predetermined level of higher in addition to the “friend relationship.” The predetermined level may be determined based on various references, for example, whether a history of conversation with a user account is present, whether it is participating in the same group chat room as the user account, whether an official account is subscribed in a case in which the user account is the official account, whether my friends are in a friend relationship with the user account, and the like.

In addition to the foregoing example, a scheme of providing a set item on the instant messaging service may be modified in various ways. Provision and application of a set item will be further described in detail with reference to FIGS. 3 through 6.

Depending on embodiments, the service server 100 or a terminal of each user may, for example, measure a number of virally spread views such as a profile view to which a set item is applied, may count a number of times that a user selects a set item corresponding to an official account or an advertiser, or may count a number of clicks of a user for each profile item included in the set item corresponding to the official account or the advertiser. The service server 100 may charge the official account or the advertiser based on the measured number of views and/or the number of clicks on the profile item.

The view to be measured may be, for example, a profile view in a state in which any of the profile items included in the set item corresponding to the official account or the advertiser is applied to the profile view for the personal account of the user.

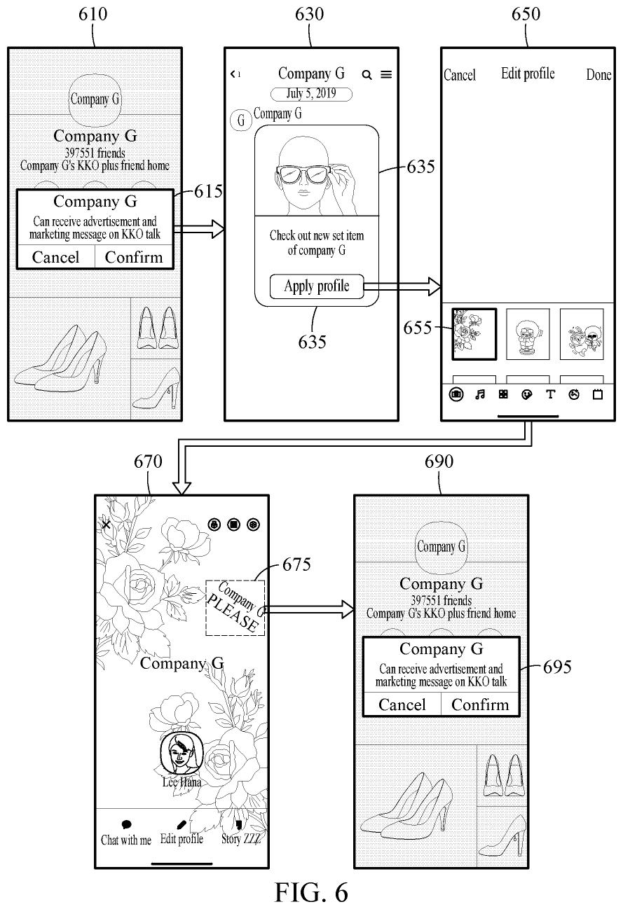

FIG. 2 is a flowchart illustrating a method of displaying a profile view according to an example embodiment. Referring to FIG. 2, in operation 210, a terminal may provide at least one set item to be applied to a profile view for a personal account. For example, the terminal may provide at least one set item in a form of a full view as illustrated in a screen 340 of FIG. 3 or provide at least one set item in a form of a thumbnail like set items included in a set item list 515 of a screen 510 of FIG. 5.

According to the example embodiment, basic set items provided in an instant messaging service may be provided. In some cases, set items associated with an official account or an advertiser may be provided. In such cases, the corresponding set item may be provided only in a case in which a predetermined condition associated with the official account or the advertiser is satisfied. In some cases, users may create set items and register the set items in a set item shop provided in the instant messaging service, so that the created set items are provided to other users. In such cases, the other users may be required to pay a predetermined cost to use the corresponding set item. The paid cost may be distributed to a creator and a provider of the instant messaging service.

In operation 220, the terminal may apply a set item selected by a user from set items to the profile view. When a first profile item applied in the profile view is present, the terminal may remove the applied first profile item and apply a second profile item included in the set item selected by the user to the profile view. In this instance, the terminal may identify a type of the first profile item, determine whether to remove the first profile item based on the type of the first profile item, and remove the first profile item. For example, when the type of the first profile item is a music item or a D-day item, the terminal may keep the first profile item instead of removing the first profile item.

Also, the terminal may determine whether the type of the first profile item applied in the profile view and the type of the second profile item included in the set item selected by the user are duplicated. The terminal may apply the second profile item to the profile view based on whether the types of the profile items are duplicated. In accordance with a determination that the type of the first profile item and the type of the second profile item are duplicated, the terminal may replace the first profile item with the second profile item, or apply the second profile item to the profile view with keeping the first profile item. When the first profile item is replaced with the second profile item, the terminal may reset settings of the first profile item and then replace the first profile item with the second profile item, or replace the first profile item with the second profile item without resetting the settings of the first profile item.

In operation 230, the terminal may provide an edit view for editing at least one profile item included in the set item applied to the profile view. The edit view may be displayed on a display of the terminal as shown in an edit view screen 550 of FIG. 5, for example. A profile item included in the set item and automatically applied to the profile view may be freely edited in the edit view. For example, in the edit view, a profile item may be removed or a profile item irrelevant to the set item may be added. In addition, in the edit view, a profile item may be moved, rotated, or changed in size. Also, in the edit view, an attribute of a profile item may be changed.

In operation 240, the terminal may display the profile view edited in operation 230 and including the set item applied in operation 220. The profile view may be displayed on the display of the terminal as shown in, for example, a profile view screen 570 of FIG. 5.

According to the example embodiment, the terminal may determine whether the personal account satisfies a predetermined condition in operation 210. The terminal may provide a set item based on whether the predetermined condition is satisfied.

For example, the terminal may determine whether the personal account satisfies the predetermined condition by making an inquiry to a service server. Also, the terminal may directly determine whether the personal account satisfies the predetermined condition.

The predetermined condition may include, for example, a first condition of establishing a friend relationship with the official account. Also, the predetermined condition may include a second condition of requesting an access to advertisement content provided in association with an official account or an advertiser, a third condition of participating in an event provided in association with an official account or an advertiser, and the like.

In this instance, the “condition of requesting the access to the advertisement content provided in association with the official account or the advertiser” may include a condition of requesting an access to, for example, an advertisement banner of the official account or the advertiser, an advertisement profile view including a set item of the official account or the advertiser, an edit view showing a set item list including the set item of the official account or the advertiser, and the like.

The predetermined condition may further request a first-come-first-served condition based on a limited number of people set in association with a provision of the set item to correspond to at least one of the second condition and the third condition.

FIG. 3 is a diagram illustrating a method of providing a set item according to an example embodiment. FIG. 3 illustrates screens 310, 330, 340, 350, and 360 provided on a terminal by an instant messaging service according to the example embodiment.

The terminal may receive, from a service server that provides the instant messaging service, a recommended list including profile views of recommended friends recommended by the service server. The terminal may configure a friend list view using the recommended list as shown in the screen 310. The terminal may display the recommended list 313 through a predetermined area in the friend list view screen 310 showing the friend list 311 of a personal account. The recommended list 313 may include at least one profile view among, for example, a profile view of a personal account of at least one another user having a friend relationship with the personal account and an advertisement profile view including a set item of an official account or an advertiser.

In this case, at least one of a position in which the advertisement profile view is displayed in the recommended list 313, an area in which the advertisement profile view is displayed, and/or a period of time for which the advertisement profile view is displayed may be set by the service server in advance. The advertisement profile view may be displayed at a position following a profile view of a personal account at least one another user included in the recommended list 313 or displayed at an Nth position in the recommended list 313, N being a natural number. In this example, at the position in which the advertisement profile view is displayed, a plurality of advertisement profile views may be displayed on the same day or one of the advertisement profile views may be displayed. Depending on embodiments, one of the advertisement profile views may be displayed only once a day to one user corresponding to the personal account.

Also, numerous advertisement profiles may be randomly displayed at the position in which the advertisement profile view is displayed. For example, when the advertisement profile view is not included in the recommended list received by the terminal from the service server, the area in which the advertisement profile view is displayed may disappear. The profile view included in the recommended list 313 may be displayed in a form of a thumbnail corresponding to each profile view as shown in the friend list view screen 310 or displayed in a form of a full view as shown in the screens 330 or 340. A user may swipe the thumbnail corresponding to the profile view included in the recommended list 313 or swiping the profile view provided in the form of the full view as shown in the screens 330 and 340, thereby selecting one profile view.

The terminal may provide the advertisement profile view to the user as shown in the screen 340 in response to a user input of selecting the advertisement profile view from the recommended list 313 included in the friend list view screen 310. After the advertisement profile view is provided, the terminal may remove the provided advertisement profile view from the recommended list. In this example, the terminal may remove the thumbnail corresponding to the advertisement profile view provided through the screen 340 from the recommended list.

For example, when the user is to apply a set item included in the advertisement profile view displayed in the screen 340 to the profile view of the user, the user may select a button “apply my profile” 345 on the screen 340. When an input of selecting the button “apply my profile” 345 is received, the terminal may determine whether the personal account satisfies the predetermined condition related to the official account or the advertiser. The terminal may determine, for example, whether the personal account is in a friend relationship with the official account. In accordance with a determination that the personal account does not satisfy the predetermined condition, the terminal may provide a user interface 355 that induces the predetermined condition to be satisfied as shown in the screen 350. The user interface 355 may be, for example, a user interface through which the personal account to establish a friend relationship with the official account. When the user selects the user interface 355 and establishes the friend relationship with the official account, the terminal may immediately apply the set item included in the advertisement profile view to its own profile view, edit the profile view, and display the edited profile view as shown in the screen 360, for example. As described above, the predetermined condition related to the official account or the advertiser may be set in various ways such as a condition of requesting an access to advertisement content of the official account or the advertiser, a condition of participating in an event related to the official account or the advertiser, or the like.

Depending on embodiments, when an input of selecting the button “apply my profile” 345 is received, the terminal may immediately apply the set item included in the advertisement profile view displayed in the screen 340 to its own profile view and edit the profile view. For example, the terminal may display the edited profile view as shown in the screen 360.

FIG. 4 is a diagram illustrating a method of displaying a banner advertisement related to a set item according to an example embodiment. FIG. 4 illustrates a banner advertisement 415 displayed in a profile view screen 410 and a banner advertisement 435 displayed in the edit view screen 430 for editing a profile view.

A terminal may display the banner advertisement 415 related to the set item in a form associated with a button for accessing an edit view, that is, a profile edit button 413 at a time when the edit view for editing the profile view is accessible, for example, when the profile view screen 410 is provided. The banner advertisement 415 may be displayed at any position adjacent to the profile edit button 413 as well as above the profile edit button 413 as shown in the profile view screen 410. In addition to the profile edit button 413, the profile view screen 410 may display a button “chat with me” and a “kakao story” connection button. Also, the profile view screen 410 may display a background image of the profile view. The background image of the profile view may be, for example, a still image or a video. The profile view screen 410 may include a play button for stopping/playing a video and a play button area for displaying a playback time of the video. The profile view screen 410 may include a sound source display area. The sound source display area may correspond to, for example, an area for performing a sound control of a sound source or video. A user may turn on/off the sound of the sound source or the video by tapping the sound source display area.

Also, the terminal may display the banner advertisement 435 related to the set item in a partial area of the edit view screen 430. In this case, the edit view screen 430 may include, for example, a profile image of a user, profile information of the user, and a set item or various icons for editing each profile item included in the set item.

In response to a selection input of the user for the banner advertisement 415 and/or the banner advertisement 435, the terminal may access the edit view for editing the profile view to which the set item is applied or access the profile view.

A banner advertisement may have, for example, a form of a tag including only a text (“company S′s set item released”) like the banner advertisement 415 or have a form including an image and a text together like the banner advertisement 435.

An exposure period of the banner advertisement 415 and/or the banner advertisement 435 of FIG. 4 may correspond to, for example, a period of time for which the advertisement profile is exposed in the friend list illustrated in FIG. 3.

FIGS. 5 and 6 are diagrams illustrating a method of inducing a personal account of a user to establish a friend relationship with an official account to provide a set item according to example embodiments. In the example embodiments of FIGS. 5 and 6, it is assumed that a predetermined condition for providing a set item is a condition of establishing a friend relationship with an official account. When the predetermined condition is a condition of requesting an access to advertisement content of an official account or an advertiser or a condition of participating in an event related to the official account or the advertiser, an interface that induces to establish the friend relationship with the official account may be replaced with an interface that induces an access to the advertisement content or an interface that induces a participation in the related event.

FIG. 5 is a diagram illustrating a method of inducing a personal account of a user to establish a friend relationship with an official account to provide a set item according to an example embodiment. FIG. 5 illustrates a process of inducing a personal account of a user to establish a friend relationship with an official account through a set item list including set items.

A terminal may, for example, enable a set item to be used on condition that a personal account of a user B establishes a friend relationship with an official account of a company G. The terminal may display, for example, an edit view screen 510 for editing a profile view of the user B. The edit view screen 510 may include, for example, a profile image of the user B, profile information of the user B, and a set item or various icons 513 for editing profile icons included in the set item. The icons 513 may correspond to, for example, types of the profile icons.

In addition, the edit view screen 510 may include the set item list 515 including various set items. The set item list 515 may include, for example, a plurality of set items such as a set item of the official account of the company G and at least one set item provided in the instant messaging service. The set item of the official account and/or the at least one set item provided in the instant messaging service may be a plurality of set item by concept, by theme, and by style, or may be a single set item. The set item list 515 may be provided through an interface of an edit view.

For example, in accordance with a determination that the personal account of the user B does not satisfy a predetermined condition associated with the official account of the company G, the terminal may display the set item of the official account of the company G as a locked state in the set item list 515 like a set item 517. When the user B selects the set item 517 displayed as the locked state in the set item list 515, the terminal may provide a user interface that induces the predetermined condition (for example, a condition that the personal account of the user B establishes the friend relationship with the official account of the company G) to be satisfied as shown in a screen 530. The user interface 535 may be provided through, for example, a pop-up screen including a button “add plus friend” for establishing the friend relationship with the official account of the company G.

When the user B adds a plus friend through the user interface 535 and the personal account of the user B is in the friend relationship with the official account of the company G, the terminal may unlock the set item of the company G as shown in a screen 550. The terminal may edit the profile view by applying the set item unlocked as shown in the screen 550 and display the edited profile view screen 570.

For example, when a user C clicks the profile view screen 570 of the user B to which the set item of the company G is applied, a terminal of the user C may display an edit view screen 590 showing a set item list including the set item of the company G. Depending on embodiments, when the user C clicks the profile view screen 570 of the user B to which the set item of the company G is applied, the terminal of the user C may display an advertisement profile view including the set item of the company G.

FIG. 6 is a diagram illustrating a method of inducing a personal account of a user to establish a friend relationship with an official account to provide a set item according to an example embodiment. FIG. 6 illustrates a process of inducing a personal account of a user to establish a friend relationship with an official account using a link item included in a set item according to the example embodiment.

When a personal account of a user B satisfies a predetermined condition associated with an official account of a company G, a terminal may provide a set item including at least one profile item corresponding to the official account of the company G.

For example, in response to the user B selecting a user interface 615 displayed in a profile view screen 610 of the company G, the personal account of the user B may establish the friend relationship with the official account of the company G. The user interface 615 may be a user interface connected to establish the friend relationship with the official account of the company G. In this case, a terminal of the user B may display a screen 630 including a user interface 635 for inquiring whether the set item of the official account of the company G is to be provided. When the user B selects the user interface 635, the terminal may display an edit view screen 650 showing a set item list including a set item 655 of the official account of the company G.

For example, when the user B selects the set item 655 displayed in the edit view screen 650, the terminal may edit a profile view by applying the set item 655 to the profile view of the user B and display an edited profile view screen 670. In this example, the profile view screen 670 may display various types of profile items such as a music item, a logo item, a sticker item, a text item, a link item 675, a background effect item, a D-day item, a background image item, a background video item, a feedback item, and the like, for example. The link item 675 may be a link item linked to the set item of the official account of the company G. The link item 675 may be, for example, in a form of a link sticker.

For example, when a user C selects the link item 675 included in a profile view screen 670 of the personal account of the user B, a terminal of the user C may display 690 a screen for inducing a personal account of the user C to establish the friend relationship with the official account of the company G. The screen 690 may be, for example, a profile view screen of the company G and may include a user interface 695 to be connected to establish the friend relationship with the official account of the company G. The user C may select the user interface 695 so that the personal account of the user C establishes the friend relationship with the official account of the company G. Through this, the user C may be provided with the set item of the official account of the company G.

The terminal may count a number of clicks on the link item 675. For example, the terminal may count the number of clicks on the link item 675 at intervals of a predetermined period and transmit the number of clicks to a service server. The service server may charge the company G based on the number of clicks received from the terminal.

Depending on embodiments, in addition to the profile view of the official account of the company G or the personal account of the profile view of the user B described above, the terminal may be provided with the set item of the official account of the company G through an offline code provided to a customer in an offline store, an outdoor advertisement, and a magazine. The offline code may have a form of, for example, a barcode, a quick response (QR) code, or a QR image. When a user D scans the offline code or uploads the offline code, a terminal of the user D may display an advertisement profile view including the set item of the official account of the company G or an edit view showing a set item list including the set item of the official account of the company G. Through the advertisement profile view or the edit view, the user D may select the set item of the official account of the company G and apply the selected set item to a profile view of the user D.

Although not shown, the service server 100 may include a communicator, a memory, and a controller. However, since the aforementioned components are not essential, the service server 100 having more components or fewer components may be implemented.

The communicator may include a terminal of the first user 101, and an electronic device, module, or program wired or wirelessly transmitting and receiving data to and from a terminal of the second user 103. A communication protocol used by the communicator may include, for example, code division multiple access (CDMA) communication, wideband code division multiple access (WCDMA) communication, or broadband wireless communication. A wireless communication network may include wireless local area network (WLAN), wireless fidelity (Wi-Fi), wireless broadband (Wibro), world interoperability for microwave access (Wimax), high speed downlink packet access (HSDPA), long term evolution (LTE), the Institute of Electrical and Electronics Engineers (IEEE) 802.16, wireless mobile broadband service (WMBS), and a communication network for 5G communication. Also, a short-range wireless communication network may include Beacon, Bluetooth, radio frequency identification (RFID), infrared data association (IrDA), ultra-wideband (UWB), ZigBee and Z-Wave. However, the present disclosure is not limited thereto.

The memory may include a dynamic storage device that stores dynamic information and instructions for execution by the controller, such as a random-access memory (RAM). However, the present disclosure is not limited thereto. Also, the memory may include a static storage device that stores static information and instructions for use by the controller, such as a read only memory (ROM). The memory may be a volatile memory unit or a nonvolatile memory unit. The memory may also be another type of computer-readable medium such as a magnetic or optical disk.

The controller may control an overall operation of a service server. The controller may include any type of typical processor, microprocessor, or processing logic to interpret and execute instructions. The controller may execute instructions stored in the memory to display graphic information for a graphical user interface (GUI) on an external input/output device such as a display coupled to a high-speed interface.

The controller may execute an operating system (OS) and one or more messenger applications executed on the operating system. In addition, the controller may access, store, manipulate, process, and generate data in response to execution of the messenger application. The messenger application may be distributed over computer systems connected through a network, and stored or executed in a distributed manner. The messenger application and the data may be stored in one or more computer-readable recording media.

According to an example embodiment, a user terminal may include a communicator, a controller, a memory, a display, and an interface to communicate with a messenger application and a service server. Since the aforementioned components of the user terminal are not essential, the user terminal having more components or fewer components may be implemented.

The messenger application may be configured to be stored in the memory and executed by the controller, and display, on the display of the user terminal, a video registered as a background of a profile view received from the service server through the interface.

Specifically, the communicator may include an electronic device, module, or program transmitting and receiving data to and from a terminal device. For example, the communicator may include a short-range communication module, a Wi-Fi communication module, and a mobile communication module. In addition, the communicator may include other short-range communication modules such as a Bluetooth module, an infrared communication module, an NFC module, and a Zigbee module, and a WLAN module.

The display may display an operation result of the controller. The operation result may be displayed based on the GUI. The display may be a component that displays various display objects. The display may be implemented with various display technologies such as an organic light emitting diode (OLED), a liquid crystal display (LCD) panel, a plasma display panel (PDP), a vacuum fluorescent display (VFD), a field emission display (FED), an electroluminescent display (ELD), and the like. Also, the display may be implemented as a flexible display, a transparent display, or the like.

The interface may receive an input from a user. The interface may include an input device such as a button-type input unit, a touch screen, a keyboard, or a mouse. For example, the touch screen may be formed on a top surface of the display and receive an input through a touch of a user. However, the present disclosure is not limited thereto.

The example embodiments described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

Software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of displaying, on a computing device, modifications to a profile view of a personal account of a user of an instant messaging application, the method comprising:
displaying, in a user interface of the instant messaging application executing on the computing device, a list view of a plurality of contact profiles using list elements, wherein the plurality of contact profiles are associated with the personal account, and wherein at least one of the plurality of contact profiles is associated with at least one second personal account of at least one second user of the instant messaging application;
receiving, from the user and via a touchscreen of the computing device, a first user input that indicates a selection of one of the plurality of contact profiles displayed in the list view, wherein a profile view of the selected contact profile comprises a set of profile editing items, wherein the set of the profile editing items is associated with content of an official account;
confirming personal account data corresponding to the user; and
confirming, based on the personal account data, whether the personal account satisfies a predetermined condition corresponding to the set of profile editing items associated with the official account,
wherein the predetermined condition corresponds to relationship establishment, by the user, with the official account provided via a user interface screen of the instant messaging application,
wherein the official account is associated with a service company,
wherein the official account is enabled to send messages corresponding to first type, to a first group of users, regardless of whether the first group of users are associated with the official account, wherein the first type does not comprise advertising type, and
wherein the official account is enabled to send messages corresponding to second type, to a second group of users, based on the second group of users being associated with the official account via relationship establishment, wherein the second type comprises advertising type;
based on a confirmation that the personal account does not satisfy the predetermined condition:
displaying, via a user interface screen of the instant messaging application executing on the computing device, a user interface element notifying the user of the predetermined condition, wherein the user interface element comprises a selectable button for satisfying the predetermined condition;
receiving, from the user and via the touchscreen of the computing device, a second user input indicating a selection of the selectable button;
based on the second user input, confirming that the personal account has satisfied the predetermined condition via relationship establishment with the official account; and
based on the confirming that the personal account has satisfied the predetermined condition, modifying the profile view of the personal account by applying a combination of the profile editing items to the profile view of the personal account; and
causing the computing device to display the modified profile view of the personal account.

2. The method of claim 1, the displaying the list view of the plurality of contact profiles comprising:
displaying, in the user interface of the instant messaging application executing on the computing device, a first list of friend profiles using first list elements and a second list of a plurality of recommended profiles using second list elements different from the first list elements, wherein the second list comprises:
first profiles corresponding to at least one of the friend profiles, wherein profile views of each of the first profiles have an edit time point within a predetermined time; and
a second profile, wherein a profile view of the second profile comprises the set of profile editing items, and wherein at least one first profile of the first profiles visually precedes the second profile in the displayed second list; and
receiving, from the user and via the touchscreen of the computing device, a third user input that indicates a selection of the second profile displayed in the second list.

3. The method of claim 1, wherein the set of profile editing items comprise a visual content item for editing a visual portion of the profile view of the personal account.

4. The method of claim 1, wherein the predetermined condition comprises a first condition of establishing a friend relationship with the official account.

5. The method of claim 1, wherein the predetermined condition comprises at least one of:
a second condition of requesting an access to advertisement content associated with the official account; or
a third condition of participating in an event associated with the official account.

6. The method of claim 1, wherein the predetermined condition is limited to a predetermined number of participants.

7. The method of claim 1, wherein at least one of the profile editing items is one or more of: a music item, a link item, or a background item,
wherein the music item comprises a play list,
wherein the link item comprises a link sticker applied to the profile view that, upon selection, directs a second user to a screen for establishing a friend relationship with an official account of a company associated with the link item, and
wherein the background item comprises one of an effect, an image, and a video that modifies a background of the profile view.

8. The method of claim 1, wherein the modifying the profile view of the personal account comprises replacing a visual content item of the profile view of the personal account with a profile editing item of the set of profile editing items by:
identifying a type of the profile editing item of the set of profile editing items; and
determining whether to replace the visual content item based on the type of the profile editing item.

9. The method of claim 2, wherein at least one of a position at which the recommended profiles are displayed in the second list and a period of time for which the recommended profiles are displayed are set in advance.

10. The method of claim 1, wherein the set of profile editing items are displayed in the profile view of the personal account in a locked state prior to satisfaction of the predetermined condition, and
wherein the set of profile editing items, in the locked state, is configured to display instructions for satisfying the predetermined condition.

11. A non-transitory computer readable medium storing instructions that, when executed, cause performance of the method of claim 1.
